(19) United States
(12) Patent Application Publication
(10) Pub. No.: US 2009/0154411 A1
(43) Pub. Date: Jun. 18, 2009

(54) TERMINAL APPARATUS, BASE STATION, RADIO COMMUNICATION METHOD AND PROGRAM STORAGE MEDIUM

(75) Inventors: Shohei Kikuchi, Tokyo (JP); Yasuhiko Tanabe, Kawasaki-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/210,646

(22) Filed: Sep. 15, 2008

(30) Foreign Application Priority Data
Dec. 18, 2007 (JP) 2007-326395

(51) Int. Cl. H04B 7/216

(52) U.S. Cl. 370/329

(57) ABSTRACT

A terminal apparatus includes: a reception unit configured to receive a signal from a base station; a channel estimation unit configured to estimate a state of a channel based on a received signal; a storage configured to store a codebook including channel state values; an index of search number acquisition unit configured to acquire index of search number of candidates to be selected from among the channel state values for a correlation calculation with the estimated state value; a candidate selecting unit configured to select candidates for which the correlation calculation should be performed from among the channel state values according to the index of search number; a correlation calculation unit configured to calculate a correlation between the estimated state value and each of selected candidates; a selection unit configured to select a candidate having a highest correlation value; and a reporting unit configured to report a selected candidate to the base station.

### CROSS REFERENCE TO RELATED APPLICATIONS

This application is based upon and claims the benefit of priority from the prior Japanese Patent Applications No. 2007-326395, filed on Dec. 18, 2007; the entire contents of which are incorporated herein by reference.

### BACKGROUND OF THE INVENTION

1. Field of the Invention

The present invention relates to a terminal apparatus that feeds back information on a channel to a base station, the base station that communicates with the terminal apparatus, a radio communication method executed by the terminal apparatus and base station and a program storage medium storing a communication program.

2. Related Art

In a Multiple Input Multiple Output (MIMO) communication with a plurality of antennas arranged in both a transmitter and a receiver, downlink transmission from a base station to a terminal apparatus (hereinafter simply referred to as a “terminal”) in particular will be thought of. In a closed loop MIMO communication, when a channel response is known to the base station side, it is possible to realize transmission that achieves a maximum capacity by multiplying a transmission signal by a transmission weight matrix obtained from the channel response. This is called “transmission beam forming.”

In the case of a Time Division Duplex (TDD) system, it is possible to assume that channel responses over an uplink and downlink are the same and the base station can determine a downlink weight matrix by estimating the uplink channel response from the terminal. However, in the case of a Frequency Division Duplex (FDD) system, a channel response is unknown to the base station side and when performing transmission beam forming, the base station obtains information on the channel through feedback of the channel response estimated by the terminal side to the base station.

When performing feedback, sending a channel as is results in a very large load on the circuit. The bandwidth actually available for feedback is limited and various ideas for reducing the amount of feedback have been proposed so far. Above all, the idea that can reduce the amount of feedback most effectively is one using a codebook. The “codebook” refers to a database common to both a transmitter and receiver made up of candidate values of a channel response matrix or candidate values of a transmission weight matrix. This is a concept that the amount of feedback can be reduced to only several bits by searching a value approximate to a value estimated on the terminal side from a codebook and feeding back only an index thereof to the base station side. The base station side can select a value corresponding to the index obtained from the codebook.

D. J. Love, R. W. Heath, Jr., and T. Strohmer, “Grassmannian beamforming for multiple-input multiple-output wireless systems,” IEEE Transactions on Information Theory, vol. 49, no. 10, pp. 2735-2747, October 2003. proposes a beam forming method when a codebook is provided with transmission weight values. In this case, the terminal side estimates a channel response first. Next, the terminal side calculates a transmission weight value using singular value decomposition or the like, selects a most suitable transmission weight value candidate from the codebook and feeds back an index thereof to the base station.

It is also possible to consider a case where a codebook is provided with not only transmission weight values but also channel response values. A value most approximate to a channel response value estimated on the terminal side is searched from a codebook and an index thereof is fed back to the base station. Next, the base station side performs processing such as singular value decomposition, calculates transmission weight values and performs beam forming.

Furthermore, D. J. Love, R. W. Heath, Jr., and T. Strohmer, “Grassmannian beamforming for multiple-input multiple-output wireless systems,” IEEE Transactions on Information Theory, vol. 49, no. 10, pp. 2735-2747, October 2003. assumes an MIMO system with a single terminal (single user), but there can also be a (multi-user) environment with a plurality of terminals. Spatial Division Multiple Access (SDMA) is becoming a focus of attention in recent years which carries out communications with a plurality of users at the same time and at the same frequency by adjusting antenna directivity patterns for a plurality of terminals to improve frequency utilization efficiency in particular. Especially when the base station is mounted with a plurality of antennas, this SDMA is also called a “MIMO-SDMA.” The terminal side may have a single antenna or a plurality of antennas.

N. Jindal, “MIMO broadcast channels with finite-rate feedback,” IEEE Transactions on Information Theory, vol. 52, no. 11, pp. 5045-5060, November 2006. proposes a method of creating a codebook using channel response values and performing beam forming in a downlink communication in this closed loop MIMO-SDMA system. In the case of a multi-user environment, the base station needs to control a weight matrix so as to suppress influences of interference between terminals on the respective terminals. Therefore, according to N. Jindal, “MIMO broadcast channels with finite-rate feedback,” IEEE Transactions on Information Theory, vol. 52, no. 11, pp. 5045-5060, November 2006, the base station controls beams with interference from other terminals suppressed based on a channel response of each terminal using Zero-Forcing or Block Diagonalization or the like using a technique similar to that when a normal channel response is fed back.

One of problems of D. J. Love, R. W. Heath, Jr., and T. Strohmer, “Grassmannian beamforming for multiple-input multiple-output wireless systems,” IEEE Transactions on Information Theory, vol. 49, no. 10, pp. 2735-2747, Oct. 2003. and N. Jindal, “MIMO broadcast channels with finite-rate feedback,” IEEE Transactions on Information Theory, vol. 52, no. 11, pp. 5045-5060, November 2006. is the amount of calculation when comparing a channel response value or weight value estimated at each terminal with a channel response candidate value or weight candidate value in a codebook. If feedback from the terminal to the base station is assumed to be performed with an amount of information of B bits, there will be 2^{B} candidate values in the codebook. That is, every time each terminal receives a signal and estimates a channel response, matching (correlation calculation) should be performed 2^{B} times, the amount of calculation of which constitutes a large load and may eventually produce a time delay and also cause throughput to deteriorate.

### SUMMARY OF THE INVENTION

According to an aspect of the present invention, there is provided with a terminal apparatus comprising:

a reception unit configured to receive a signal from a base station;

a channel estimation unit configured to estimate a state of a channel based on a received signal to obtain an estimated state value of the channel;

a storage configured to store a codebook including a plurality of channel state values;

an index of search number acquisition unit configured to acquire index of search number representing a number of candidates to be selected from among the channel state values in the codebook for a correlation calculation with the estimated state value;

a candidate selecting unit configured to select candidates for which the correlation calculation with the estimated state value should be performed from among the channel state values according to the index of search number;

a correlation calculation unit configured to calculate a correlation between the estimated state value and each of selected candidates;

a selection unit configured to select a candidate having a highest correlation value from among the selected candidates; and

a reporting unit configured to report a selected candidate to the base station.

According to an aspect of the present invention, there is provided with a communication method comprising:

receiving a signal from a base station;

estimating a state of a channel based on a received signal to obtain an estimated state value of the channel;

providing a codebook including a plurality of channel state values;

acquiring index of search number representing a number of candidates to be selected from among the channel state values in the codebook for a correlation calculation with the estimated state value;

selecting candidates for which the correlation calculation with the estimated state value should be performed from among the channel state values in the codebook according to the index of search number;

calculating a correlation between the estimated state value and each of selected candidates;

selecting a candidate having a highest correlation value from among the selected candidates; and

reporting a selected candidate to the base station.

According to an aspect of the present invention, there is provided with a program storage medium storing a computer program for causing a computer to execute instructions to perform the steps of:

receiving a signal from a base station;

estimating a state of a channel based on a received signal to obtain an estimated state value of the channel;

reading out a codebook including a plurality of channel state values from a codebook storage;

acquiring index of search number representing a number of candidates to be selected from among the channel state values in the codebook for a correlation calculation with the estimated state value;

selecting candidates for which the correlation calculation with the estimated state value should be performed from among the channel state values in the codebook according to the index of search number;

calculating a correlation between the estimated state value and each of selected candidates;

selecting a candidate having a highest correlation value from among the selected candidates; and

reporting a selected candidate to the base station.

According to an aspect of the present invention, there is provided with a base station for communicating with a terminal apparatus, the terminal apparatus estimating a state of a channel to obtain an estimated state value of the channel and calculating a correlation between the estimated state value and each of candidates selected from a codebook which includes channel state values to detect a candidate having a high correlation with the estimated state value, comprising:

a quality measuring unit configured to measure quality of a channel between the base station and the terminal apparatus;

a storage configured to store a base station side codebook having same contents as the codebook of the terminal apparatus;

an index acquisition unit configured to acquire an index of the candidate detected by the terminal apparatus from the terminal apparatus;

a selecting unit configured to select a channel state value having an acquired index from the base station side codebook;

a weighted signal generation unit configured to multiply a transmission signal to the terminal apparatus by a weight depending on a selected channel state value to generate a weighted signal;

a transmission unit configured to transmit the weighted signal to the terminal apparatus;

an index of search number determining unit configured to determine index of search number representing a number of the candidates to be selected from the codebook in the terminal apparatus, based on measured quality of the channel; and

a reporting unit configured to report the index of search number to the terminal apparatus.

According to an aspect of the present invention, there is provided with a communication method performed by a base station which communicates with a terminal apparatus, the terminal apparatus estimating a state of a channel to obtain an estimated state value of the channel and calculating a correlation between the estimated state value and each of candidates selected from a codebook which includes channel state values to detect a candidate having a high correlation with the estimated state value, comprising:

measuring quality of a channel between the base station and the terminal apparatus;

providing a storage configured to store a base station side codebook having same contents as the codebook of the terminal apparatus;

acquiring the candidate detected by the terminal apparatus from the terminal apparatus;

selecting a channel state value having an acquired index from the base station side codebook;

multiplying a transmission signal to the terminal apparatus by a weight depending on a selected channel state value to generate a weighted signal;

transmitting the weighted signal to the terminal apparatus;

determining index of search number representing a number of the candidates to be selected from the codebook in the terminal apparatus, based on measured quality of the channel; and

reporting the index of search number to the terminal apparatus.

According to an aspect of the present invention, there is provided with a program storage medium storing a computer program for causing a base station which communicates with a terminal apparatus, the terminal apparatus estimating a state of a channel to obtain an estimated state value of the channel and calculating a correlation between the estimated state value and each of candidates selected from a codebook which includes channel state values to detect a candidate having a high correlation with the estimated state value, to execute instructions the steps of:

measuring quality of a channel between the base station and the terminal apparatus;

reading out a base station side codebook identical to the codebook of the terminal apparatus, from a codebook storage;

acquiring an index of the candidate detected by the terminal apparatus from the terminal apparatus;

selecting a channel state value having an acquired index from the base station side codebook;

multiplying a transmission signal to the terminal apparatus by a weight depending on a selected channel state value to generate a weighted signal;

transmitting the weighted signal to the terminal apparatus;

determining index of search number representing a number of the candidates to be selected from the codebook in the terminal apparatus, based on measured quality of the channel; and

reporting the index of search number to the terminal apparatus.

### BRIEF DESCRIPTION OF THE DRAWINGS

FIG. 1 is a schematic diagram of a radio communication system according to a first embodiment of the present invention;

FIG. 2 is a block diagram schematically showing the configuration of a base station according to the first embodiment of the present invention;

FIG. 3 is a block diagram schematically showing the configuration of a terminal apparatus according to the first embodiment of the present invention;

FIG. 4 is a diagram showing a codebook searching method according to the first embodiment of the present invention;

FIG. 5 is a block diagram schematically showing the configuration of a base station according to a second embodiment of the present invention;

FIG. 6 is a block diagram schematically showing the configuration of a terminal apparatus according to the second embodiment of the present invention;

FIG. 7 is a diagram showing a codebook searching method according to the second embodiment of the present invention;

FIG. 8 is a block diagram schematically showing the configuration of a base station according to a third embodiment of the present invention;

FIG. 9 is a block diagram showing a schematic configuration of a terminal apparatus according to the third embodiment of the present invention;

FIG. 10 is a block diagram schematically showing the configuration of a base station according to a fourth embodiment of the present invention;

FIG. 11 is block diagram schematically showing the configuration of a terminal apparatus according to the fourth embodiment of the present invention; and

FIG. 12 is a diagram showing a codebook searching method according to a seventh embodiment of the present invention.

### DETAILED DESCRIPTION OF THE INVENTION

### First Embodiment

This embodiment assumes a case where a MIMO-SDMA (Multiple Input Multiple Output-Spatial Division Multiple Access) scheme is used over a downlink in a radio communication system constructed of a base station mounted with an array antenna made up of M antenna elements and K terminal apparatuses (hereinafter simply referred to as “terminals”) mounted with Nₖ antenna elements (k=1, . . . , K). Furthermore, suppose a signal with Lₖ streams is sent to a kth terminal. Here, there is a relationship of Lₖ≦Nₖ.

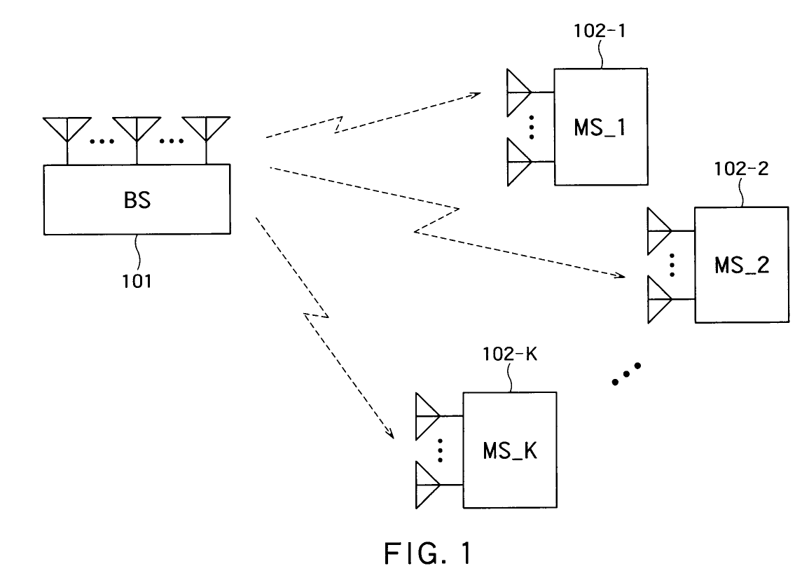

FIG. 1 schematically shows a radio communication system constructed of one base station mounted with M antenna elements and a plurality of terminals mounted with Nₖ antenna elements. Here, a radio communication within a single cell will be considered and one base station 101 communicates with a plurality of terminals 102-1, 102-2, . . . 102-K. Furthermore, a Frequency Division Duplex (FDD) system is assumed and suppose the base station 101 always acquires information on channels (information on channel responses in this embodiment) through feedback from the terminals 102-1, 102-2, . . . 102-K.

When the number of terminals is 2 or more, the base station sends a signal to a plurality of terminals at the same time and at the same frequency. Various methods can be used as the transmission method when feeding back information from each terminal to the base station such as a Time Division Multiple Access (TDMA) scheme, Frequency Division Multiple Access (FDMA) scheme and SDMA scheme.

Hereinafter, a series of processes between the base station and terminals according to this embodiment will be explained one by one. For simplicity, these processes will be explained in sequential order; the terminal receives a signal, then estimates a channel response, performs a search of a codebook and matching (correlation calculation), feeds back information on the channel response to the base station, the base station determines a transmission weight value and transmits a signal to the terminals.

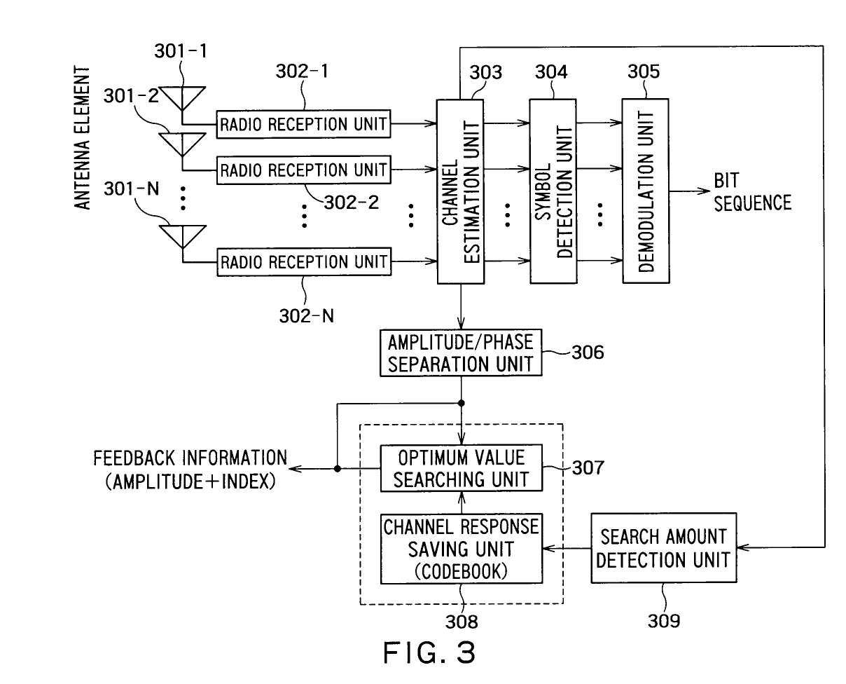

FIG. 3 schematically shows the configuration of the terminal according to this embodiment. A radio signal received at antenna elements 301-1, 301-2, . . . 301-N are inputted to a channel estimation unit 303 through radio reception units 302-1, 302-2, . . . 302-N. Here, if the signal received by the respective antenna elements 301-1, 301-2, 301-N at a kth terminal is assumed to be (x₁^{(k)}, . . . ,x_{N}_{ₖ}^{(k)}), the received signal vector x^{(k)}=[x₁^{(k)}, . . . ,x_{N}_{ₖ}^{(k)}]^{T} is expressed by following Expression 1.

x^{(k)}=H^{(k)}s^{(k)}+n^{(k)} Expression 1

Here, H^{(k)} is a channel response matrix with Nₖ rows and Lₖ columns, s^{(k)}=[s₁^{(k)}, . . . ,s_{L}_{ₖ}^{(k)}]^{T} is a transmission signal vector with Lₖ rows and n^{(k)} is additional noise with Nₖ rows. The channel estimation unit 303 calculates an estimated value Hₑₛₜ^{(k)} of the channel response matrix H^{(k)} from the received signal in above described Expression 1. This estimated value (channel response estimated value) is an example of estimated state value of the channel. The “estimated state value of the channel” is a value that estimates the state of a channel and includes, for example, estimated channel response value or various index values (e.g., transmission weight value used for beam forming) that can be calculated from the estimated channel response value. The case where the state estimated value of the channel is a transmission weight value will be explained in detail in a second embodiment.

Next, a symbol detection unit 304 calculates an estimated value sₑₛₜ^{(k)} of the transmission signal s^{(k)} using the estimated channel response matrix Hₑₛₜ^{(k)}.

Next, a demodulation unit 305 converts the calculated estimated value to a bit sequence dₑₛₜ^{(k)} with Lₖ rows.

Furthermore, the number of columns of the channel response matrix Hₑₛₜ^{(k)} estimated by the channel estimation unit 303 corresponds to the number of streams transmitted to the kth terminal and an amplitude/phase separation unit 306 separates each column (each stream) into an amplitude component αₗ^{(k)} and a phase component hₗ^{phase,(k)} as shown in Expression 2 below.

αₗ^{(k)}=|hₗ^{(k)}|, l=1, . . . ,Lₖ

hₗ^{phase,(k)}=hₗ^{(k)}/|hₗ^{(k)}|, l=1, . . . ,Lₖ Expression 2

The phase component hₗ^{phase,(k)} obtained at the amplitude/phase separation unit 306 is inputted to an optimum value searching unit 307 for matching with a codebook. The amplitude component αₗ^{(k)} is fed back to the base station together with an index obtained at the optimum value searching unit 307.

A channel response saving unit 308 saves the codebook made up of a set (h₁^{code}, . . . ,h₂_{^{B}}^{code}) of channel response values (here, phase components). The subscript “h” indicates an index in the codebook. The size of the codebook (that is, the number of channel response values (here, phase components) saved in the codebook) is 2^{B} assuming that the size of the index (number of bits) is B. All 2^{B} channel response values (here, phase components) are complex vectors having a magnitude of 1 and randomly generated. The channel response value is an example of channel state value. The “channel state value” is a value indicating the state of a channel and includes, for example, channel response value or various index values (e.g., transmission weight values used for beam forming) that can be calculated from the channel response value. The second embodiment which will be described later will explain a case where a codebook is made up of transmission weight values.

Examples of the codebook creating method include, one called “Grassmaniann Line Packing”, one called “Lloyd algorithm” and any method may be adopted without problems. Moreover, the codebook used may be a fixed one or made changeable according to the channel situation.

Here, the channel response values (here, phase components) in the codebook need to be arranged in order of phases. h₁^{code} corresponding to the first value of the index may be arbitrarily determined, but the subsequent channel response values need to be arranged in order of phases based on the vector selected as h₁^{code}. That is, the vector having the highest correlation with h₁^{code} is h₂^{code} followed by h₃^{code}. Hereafter, the correlation with h₁^{code} decreases as the index increases.

A search amount detection unit 309 acquires a parameter P₁^{(k)} indicating the amount of codebook search for each stream reported from the base station from the channel estimation unit 303. The amount of codebook search is included, for example, in a preamble of the received signal from the base station and the channel estimation unit 303 extracts the amount of codebook search from this preamble and passes the amount of codebook search to the search amount detection unit 309. The search amount detection unit 309 reports the amount of codebook search passed from the channel estimation unit 303 to the channel response saving unit 308. The amount of codebook search corresponds, for example, to the number of candidates to be subjected to a correlation calculation in the codebook. The search amount detection unit 309 is an example of the index of search number acquisition unit that acquires the number of candidates (here, phase component), for example.

The channel response saving unit 308 selects a channel response value (here, phase component) for matching (correlation calculation) with the output (phase component of channel response estimated value) of the amplitude/phase separation unit 306 from the codebook according to the parameter Pₗ^{(k)} of the amount of search and passes the channel response value to the optimum value searching unit 307. The channel response saving unit 308 includes, for example, a candidate selecting unit that selects candidates to be subjected to a correlation calculation in the codebook. The optimum value searching unit 307 calculates a correlation (matching) between each channel response value (here, phase component) selected by the channel response saving unit 308 and the output (phase component of the channel response estimated value) of the amplitude/phase separation unit 306.

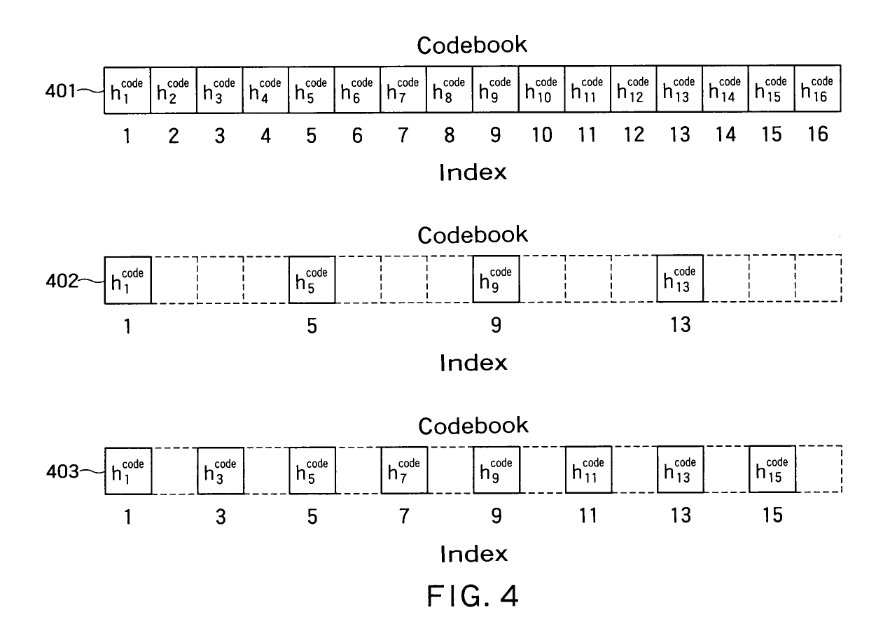

More specifically, the channel response saving unit 308 selects a channel response value (here, phase component) to be subjected to matching (correlation calculation) with the output of the amplitude/phase separation unit 306 at intervals of 2^{B-P}^{ₗ}^{^{(k)}}−1 values from hₗ_{₀}^{code} (l₀<2^{B-P}^{ₗ}^{^{(k)}}) from the codebook. For example, assuming B=4, P₁^{(k)}=2, P₂^{(k)}=3, the entire codebook is composed of 2^{B}=16 vectors as denoted by reference numeral 401 in FIG. 4. From P₁^{(k)}=2, the first stream is selected at intervals of three value from h₁^{code} assuming, for example, l₀=1 as shown by reference numeral 402 in FIG. 4, and the selected [h₁^{code}, h₅^{code}, h₉^{code}, h₁₃^{code}] is subjected to matching with the first column h_{est,1}^{phase(k)} of the output of the amplitude/phase separation unit 306 by the optimum value searching unit 307. Likewise, the second stream from P₂^{(k)}=3 is selected at intervals of one value from h₁^{code}, for example, and the selected [h₁^{code}, h₃^{code}, h₅^{code}, h₇^{code}, h₉^{code}, h₁₁^{code}, h₁₃^{code}, h₁₅^{code}] is subjected to matching with the second column h_{est,2}^{phase,(k)} of the output of the amplitude/phase separation unit 306 by the optimum value searching unit 307.

In this way, this embodiment can drastically reduce the number of matchings compared with the conventional method. That is, the conventional total search requires matching with 16 channel response values (here, phase components) to be performed and thereby requires a total of 32 (16×2=32) matchings in two streams, whereas this embodiment only requires a total of 12 (4+8=12) matchings in two streams. That is, this embodiment can be said to change the size of the required codebook according to the required accuracy. Generally, the greater the size of the codebook, the greater is the number of channel response values (here, phase components) from which a choice can be made, and therefore a large codebook is known to have higher communication accuracy. With attention focused on this point, according to this embodiment, the base station controls the size (amount of search) of the codebook to be searched according to the quality of the channel and thereby reduces the amount of search while maintaining accuracy to a certain extent.

The optimum value searching unit 307 calculates a correlation between each column of the output (phase component hₗ^{phase,(k)}) of the amplitude/phase separation unit 306 and each channel response value (here, phase component) selected by the channel response saving unit 308 as shown above, then selects the one with the highest correlation value as the optimum channel response value (here, phase component) and outputs an index thereof. The optimum value searching unit 307 includes, for example, a correlation calculation unit that carries out a correlation calculation and a selection unit that selects a channel response value (here, phase component) having the highest correlation value.

Finally, the index which is the output of the optimum value searching unit 307 and a positive real number αₗ^{(k)} corresponding to the amplitude having the channel response estimated value shown by above described Expression 2 obtained at the amplitude/phase separation unit 306 is fed back to the base station as feedback information. The terminal apparatus includes a reporting unit that reports the index of the selected channel response value (here, phase component) to the base station.

Next, the process of processing on the base station side will be explained.

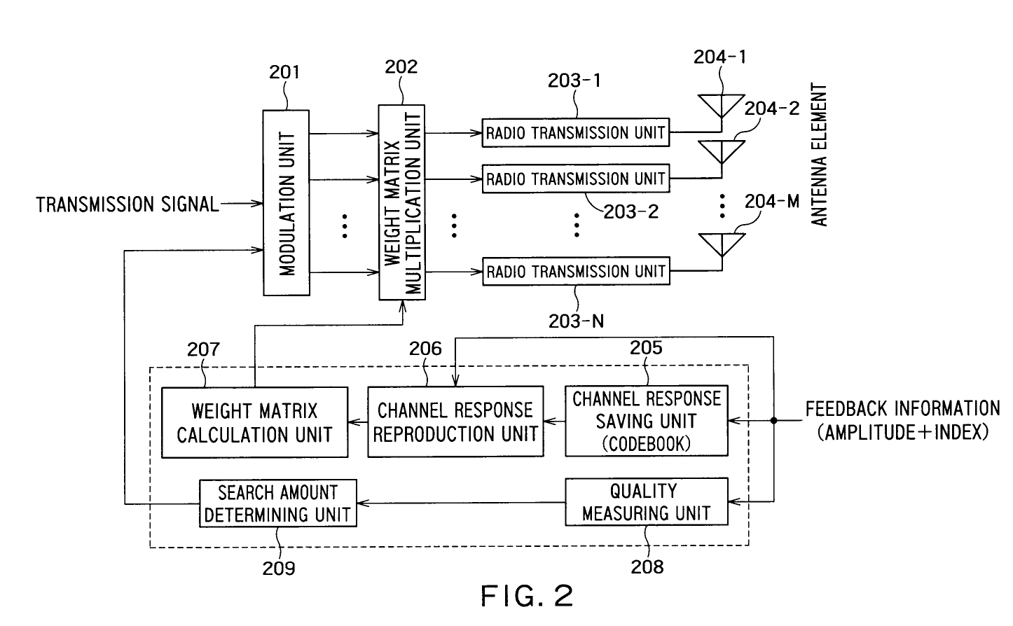

FIG. 2 schematically shows the configuration of the base station of this embodiment. Feedback information (here the amplitude of the channel and index of the codebook) is returned from the terminal, the index of the codebook is inputted to a channel response saving unit 205 and the amplitude information αₗ^{(k)} (l=1, . . . ,Lₖ,k=1, . . . ,K) of the channel is inputted to a channel response reproduction unit 206. Furthermore, the feedback information returned from the terminal is inputted to a quality measuring unit 208. The channel response saving unit 205 includes an index acquisition unit that acquires an index from the terminal apparatus.

The channel response saving unit 205 saves the same codebook (base station side codebook) as that of the channel response saving unit 308 in FIG. 3. The channel response saving unit 205 selects a channel response value (phase h_{l,selected}^{code,(k)}) corresponding to the index fed back from the terminal and outputs the selected channel response value (phase h_{l,selected}^{code,(k)}) to the channel response reproduction unit 206. The channel response saving unit 205 includes a selection unit that selects a channel state value (channel response value) corresponding to the index.

The channel response reproduction unit 206 multiplies the amplitude αₗ^{(k)} of the fed back channel by the phase information h_{l,selected}^{code,(k)} of the channel response inputted from the channel response saving unit 205 and this causes the channel response value H_{selected}^{(k)}=[h_{l,selected}^{code(k)}, . . . ,h_{N}_{ₖ}_{,selected}^{code(k)}] to be reproduced. This reproduced channel response value is inputted to a weight matrix calculation unit 207.

The weight matrix calculation unit 207 receives H_{selected}^{(k)} with M rows and Nₖ columns corresponding in number to terminals (K terminals) as input and calculates transmission weight vectors vₗ

$$( l = 1 , L , {\sum }_{k = 1}^{K} {L}_{k} )$$

assigned to the streams of the respective terminals. There can be various calculation methods, but a downlink MIMO-SDMA communication requires weights that will suppress interference between terminals.

The quality measuring unit 208 measures a parameter regarding the quality of each stream of each terminal based on the feedback information fed back from each terminal. Specific examples of the “parameter regarding the quality” include a signal to interference noise ratio (SINR). The measured parameters are inputted to a search amount determining unit 209. SINR is an example of information indicating the degree of interference between terminal apparatuses. When phase information on an index included in the feedback information is necessary, the phase information on the index may be acquired with reference to the codebook in the channel response saving unit 205. Here, the quality measuring unit 208 measures the quality parameter based on the feedback information from each terminal, but the parameter regarding the quality of each stream of each terminal may also be measured directly using the received signal from each terminal received at antenna elements 204-1, 204-2, . . . 204-M.

The search amount determining unit 209 stores a table of correspondence between SINR and parameter P₁^{(k)} indicating the amount of search of the codebook. That is, when an SINR value is inputted, the parameter value regarding the amount of search of the codebook is given as a natural number of B or less. The higher the SINR value, the smaller value is set as the parameter regarding the amount of search. That is, the higher the quality of a channel, the smaller size (amount of search) of the codebook to be searched is set. The search amount determining unit 209 corresponds, for example, to an index of search number acquisition unit that acquires index of search number representing the number of candidates (amount of search) selected from the codebook for a correlation with the estimated state value.

In this way, a weight matrix for transmission beam forming by which each stream is multiplied and the amount of codebook search to be reported to each stream are determined. The information on the determined amount of search is inputted to a modulation unit 201 together with data information

$$d = {[ {d}_{1} , … , {d}_{{\sum }_{k = 1}^{K} {L}_{k}} ]}^{T}$$

sent as part of a transmission signal sequence through processing such as being incorporated in a preamble.

The modulation unit 201 modulates the inputted signal and generates a modulated signal. A weight matrix multiplication unit (weighted signal generation unit) 202 generates a multiplied signal (weighted signal) by multiplying the modulated signal by a weight matrix. That is, assuming the modulated signal is

$$s = {[ {s}_{1} , … , {s}_{{\sum }_{k = 1}^{K} {L}_{k}} ]}^{T} ,$$

the modulated signal s is multiplied by an output matrix

$$V = [ {v}_{1} , … , {v}_{{\sum }_{k = 1}^{K} {L}_{k}} ]$$

of the weight matrix calculation unit 207 and a multiplied signal (vector V·s) is generated. The respective elements of the multiplied signal are emitted from the antenna elements 204-1, 204-2, . . . 204-M through radio transmission units 203-1, 203-2, . . . 203-N.

The terminal receives signal sent from the base station through the antenna elements 301-1, 301-2, . . . 301-N and carries out the aforementioned processing on the terminal side thereafter.

As described above, according to this embodiment, the terminal performs matching with only the channel response value (here, phase component) of the amount of search reported from the base station, and can thereby drastically reduce the calculation load on the terminal compared with the conventional method whereby matching is performed with all channel response values (here, phase components) in the codebook. Therefore, the delay time and back off are reduced and throughput of the entire system is improved.

### Second Embodiment

In the first embodiment, a codebook is made up of channel response values (here, phase components), but this embodiment has a feature that a codebook is made up of transmission weight values. Hereinafter, this embodiment will be explained in detail.

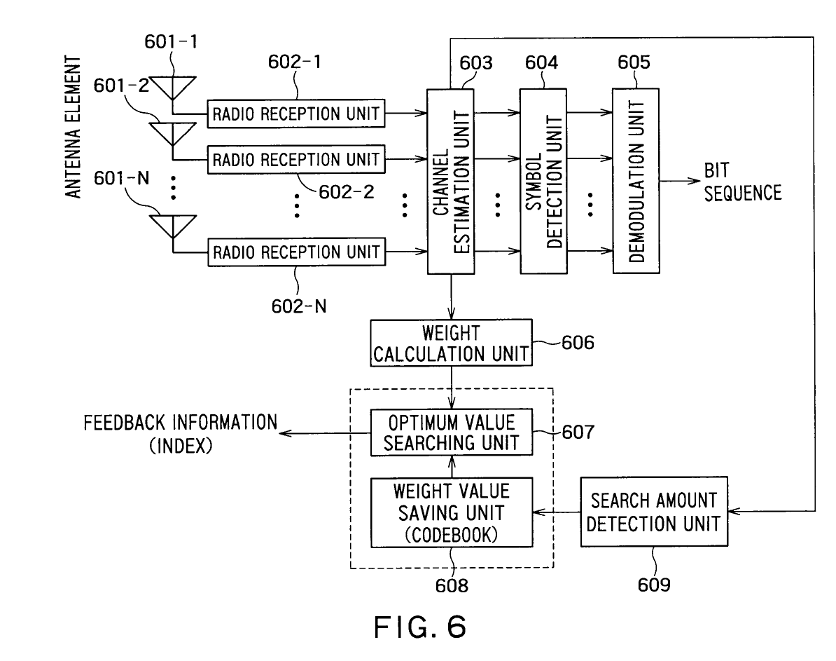

FIG. 6 schematically shows the configuration of a terminal according to the second embodiment. A radio signal received at antenna elements 601-1, 601-2, . . . 601-N is inputted to a channel estimation unit 603 through radio reception units 602-1, 602-2, . . . 602-N. Here, at a kth terminal, the signal received at the respective antenna elements 601-1, 601-2, . . . 601-N is expressed by above described Expression 1.

The channel estimation unit 603 calculates an estimated value Hₑₛₜ^{(k)} of a channel response matrix H^{(k)} from the received signal expressed by above described Expression 1.

A symbol detection unit 604 calculates an estimated value sₑₛₜ^{(k)} of a transmission signal s^{(k)} using the channel response matrix Hₑₛₜ^{(k)} estimated at the channel estimation unit 603. Next, a demodulation unit 605 converts the estimated value of the transmission signal to a bit sequence dₑₛₜ^{(k)} with Lₖ rows.

A search amount detection unit 609 receives a parameter Pₗ^{(k)} indicating the amount of codebook search for each stream reported from the base station from the channel estimation unit 603. The amount of codebook search is included, for example, in a preamble of the received signal from the base station and the channel estimation unit 603 extracts the amount of codebook search from this preamble and passes the amount of codebook search to the search amount detection unit 609. The search amount detection unit 609 sends the amount of codebook search passed from the channel estimation unit 603 to a weight value saving unit 608. The search amount detection unit 609 is an example of the index of search number acquisition unit that acquires index of search number representing the number of candidates (amount of search) selected from the codebook for a correlation calculation.

A weight calculation unit 606 calculates a transmission weight matrix Vₑₛₜ^{(k)} from the channel response matrix Hₑₛₜ^{(k)} estimated by the channel estimation unit 603. Examples of the calculation method include a method using singular value decomposition as shown in Expression 3 below. The transmission weight matrix or elements thereof (transmission weights) corresponds to an example of an estimated state value indicating the estimated state of a channel and a set of the channel estimation unit 603 and weight calculation unit 606 is an example of a channel estimation unit that obtains the estimated state value of the channel by estimating the channel based on the received signal.

Hₑₛₜ^{(k)}=Uₑₛₜ^{(k)}Dₑₛₜ^{(k)}Vₑₛₜ^{(k)H} Expression 3

The weight value saving unit 608 stores a codebook made up of a set (v₁^{code}, . . . ,v₂_{^{B}}^{code}) of weight values. The subscript “v” represents an index in the codebook. The size of the codebook (that is, the number of weight values saved in the codebook) is 2^{B} assuming that the size (number of bits) of the index of weight value is B. All 2^{B} weight values are complex vectors having a magnitude of 1 and are generated randomly.

Examples of the codebook creating method include one called “Grassmaniann Line Packing” and one called “Lloyd algorithm” and any method can be used without problems. Furthermore, the codebook may be a fixed one or made variable according to, for example, the situation of the channel.

However, the weight values in the codebook need to be arranged in order of phases. v₁^{code} corresponding to the first value of the index may be determined arbitrarily, but the subsequent values should be arranged in order of phases relative to the vector selected as v₁^{code}. That is, the vector having the highest correlation with v₁^{code} is v₂^{code} followed by v₃^{code}. Correlativity with v₁^{code} decreases as the index increases hereinafter.

The weight value saving unit 608 selects a weight value (candidate) to be subjected to matching with the output (calculated transmission weight value) of the weight calculation unit 606 according to the parameter Pₗ^{(k)} of the amount of search received from the search amount detection unit 609 from the codebook and passes the selected weight value to an optimum value searching unit 607. The weight saving unit 608 includes a candidate selecting unit that selects, for example, candidates (here, weight values) to be subjected to a correlation calculation. The optimum value searching unit 607 calculates a correlation (matching) between each weight value selected by the weight value saving unit 608 and the output (calculated transmission weight value) of the weight calculation unit 606.

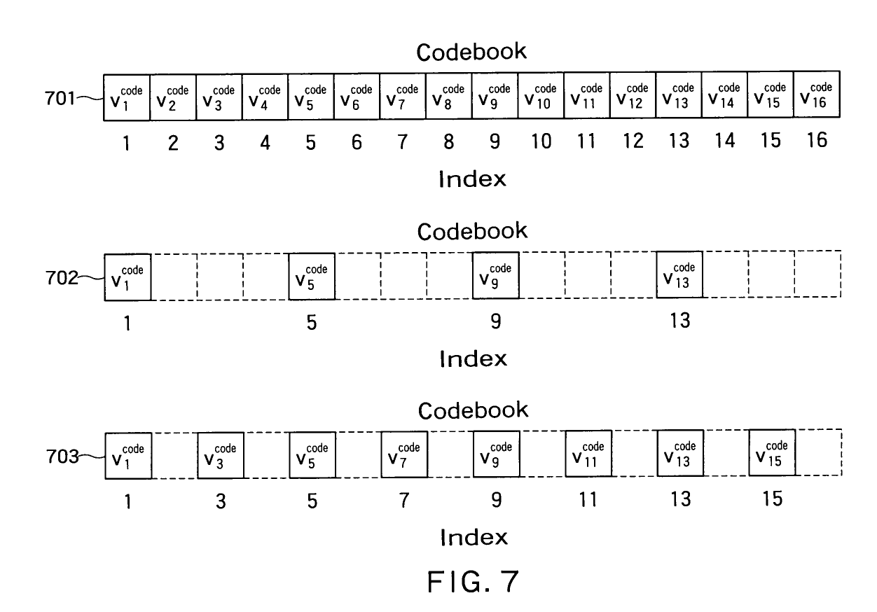

More specifically, the weight saving unit 608 selects a weight value for matching with the output of the weight calculation unit 606 at intervals of 2^{B-P}^{₁}^{^{(k)}}−1 vectors from vₗ_{₀}^{code} (l₀<2^{B-P}^{₁}^{^{(k)}}) from the codebook. For example, assuming B=4, P₁^{(k)}=2, P₂^{(k)}=3 here, the entire codebook is made up of 2^{B}=16 vectors as shown by reference numeral 701 in FIG. 7. Since P₁^{(k)}=2, the first stream is selected at intervals of three vectors from v₁^{code} assuming, for example, l₀=1 as shown by reference numeral 702 in FIG. 7 and these [v₁^{code},v₅^{code},v₉^{code},v¹³^{code}] are subjected to matching with the first column v_{est,1}^{phase,(k)} of the output of the weight calculation unit 606 by the optimum value searching unit 607. Likewise, since P₂^{(k)}=3, as shown by reference numeral 703 in FIG. 7, the second stream is selected, for example, at intervals of 1 vector from v₁^{code} and these [v₁^{code},v₃^{code},v₅^{code},v₇^{code},v₉^{code},v₁₁^{code},v₁₃^{code},v₁₅^{code}] are subjected to matching with the second column v_{est,2}^{(k)} of the output of the weight calculation unit 606 by the optimum value searching unit 607.

In this way, this embodiment can drastically reduce the number of matchings compared with the conventional method. That is, in a conventional total search, matching with 16 weight values needs to be performed and since 16×2=32 and a total of 32 matchings are required in two streams, whereas in this embodiment, since 4+8=12, only a total of 12 matchings are required.

As described above, after calculating a correlation between each column of the output of the weight calculation unit 606 and each weight value selected by the weight value saving unit 608, the optimum value searching unit 607 selects the one having the highest correlation as an optimum weight value and outputs an index thereof. The optimum value searching unit 607 includes, for example, a correlation calculation unit that performs a correlation calculation and a selection unit that selects a weight value having the highest correlation value.

Finally, the index which is the output of the optimum value searching unit 707 is fed back to the base station as feedback information. The terminal apparatus includes a reporting unit that reports the index of the selected weight value to the base station.

In the above described embodiment, matching is performed after calculating a weight value through singular value decomposition as shown in Expression 3 above and the weight value with the highest correlation is determined as the optimum weight value, but it is also possible to consider a method of calculating reception power from the channel response value estimated at the channel estimation unit 603 and the weight values of the codebook according to Expression 4 and assuming the weight value corresponding to maximum reception power as the optimum weight value. In this case, “I” (index) which minimizes the value in Expression 4 is selected and this value is fed back to the base station side. In addition, a method of maximizing the communication capacity may also be considered.

vₗ^{codeH}Hₑₛₜ^{(k)H}Hₑₛₜ^{(k)}vₗ^{code},l=1,L,2^{B} Expression 4

Next, the process of processing on the base station side will be explained.

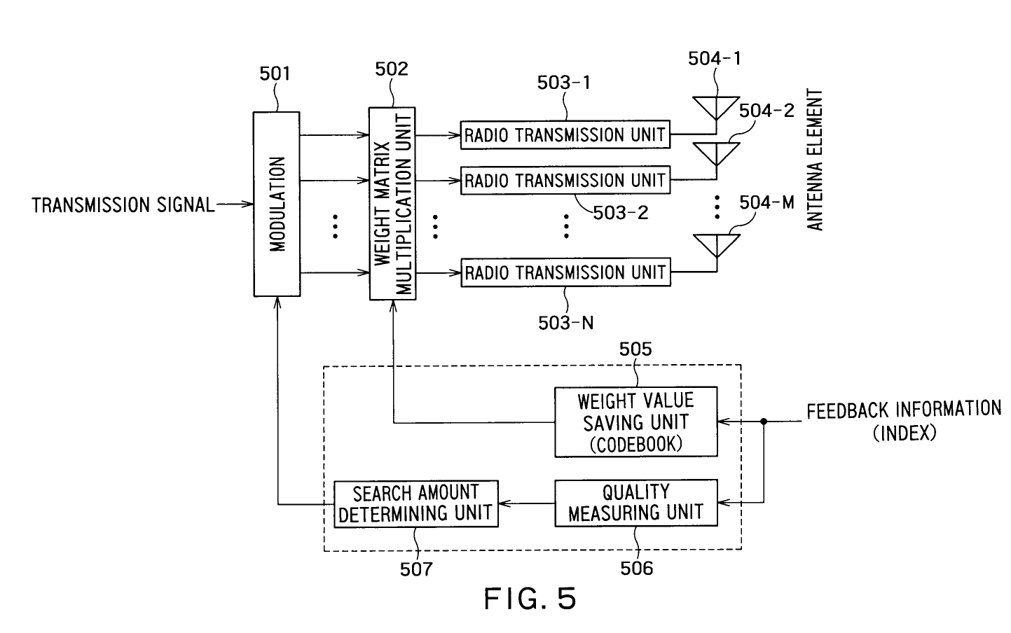

FIG. 5 schematically shows the configuration of the base station according to this embodiment. Feedback information (here, index of the codebook) is returned from the terminal and the feedback information is inputted to a weight value saving unit 505 and a quality measuring unit 506. Here, the weight value saving unit 505 stores the same codebook (base station side codebook) as that in the weight value saving unit 608 in FIG. 6. The weight value saving unit 505 includes an index acquisition unit that acquires an index from the terminal apparatus.

The weight value saving unit 505 selects a weight value corresponding to the fed back feedback information (here, index) and the selected weight value is multiplied by a transmission signal at a weight matrix multiplication unit 502. The weight value saving unit 505 includes a selection unit that selects a channel state value (weight value) corresponding to an index.

The quality measuring unit 506 refers to the codebook in the weight value saving unit 505 based on the feedback information fed back from each terminal (here, index), acquires a weight value corresponding to the index and measures a parameter regarding the quality of each stream at each terminal. Examples of the “parameter regarding quality” more specifically include a signal to interference noise ratio (SINR). The measured parameter is inputted to a search amount determining unit 507 that follows. Here, the quality measuring unit 506 measures the quality parameter based on the feedback information fed back from each terminal, but it is also possible to directly use the received signal from each terminal received at antenna elements 504-1, 504-2, . . . 504-M and measure parameters regarding quality of each stream at each terminal.

The search amount determining unit 507 stores a table of correspondence between SINRs and parameters Pₗ^{(k)} regarding the amount of search of the codebook. That is, when an SINR value is inputted, the value of a parameter regarding the amount of search of the codebook is given as a natural number of B or less. As the SINR value increases, the parameter regarding the amount of search is set to a smaller value. The search amount determining unit 507 corresponds, for example, to an index of search number acquisition unit that determines index of search number representing the number of candidates to be subjected to a correlation calculation.

As described above, a weight matrix for transmission beam forming by which each stream is multiplied and amount of codebook search corresponding to each stream are determined. The information on the amount of search is inputted to a modulation unit 501 together with data information

$$d = {[ {d}_{1} , … , {d}_{{\sum }_{k = 1}^{K} {L}_{k}} ]}^{T}$$

sent as part of the transmission signal sequence through processing such as being incorporated in a preamble.

The modulation unit 501 modulates the inputted signal and generates a modulated signal. The weight matrix multiplication unit (weighted signal generation unit) 502 generates a multiplied signal (weighted signal) by multiplying the modulated signal by a weight matrix. That is, assuming the modulated signal is

$$s = {[ {s}_{1} , … , {s}_{{\sum }_{k = 1}^{K} {L}_{k}} ]}^{T} ,$$

the weight matrix multiplication unit 502 multiplies the modulated signal s by the weight matrix (the output matrix

$$V = [ {v}_{1} , … , {v}_{{\sum }_{k = 1}^{K} {L}_{k}} ]$$

of weight value saving unit 505) and generates a multiplied signal (vector·S). Each element of the multiplied signal is emitted as a radio wave into space from the antenna elements 504-1, 504-2, . . . 504M through radio transmission units 503-1, 503-2, . . . 503N.

The terminal receives a signal sent from the base station through the antenna elements 601-1, 601-2, . . . 601-N and carries out processing on the terminal side as described above thereafter.

As described above, according to this embodiment, since the terminal performs matching only with weight values corresponding to the amount of search reported from the base station, the calculation load on the terminal is drastically reduced compared to the conventional method which performs matching with all weight values in the codebook. Therefore, the delay time and back off are reduced and throughput of the entire system is improved.

### Third Embodiment

In the first embodiment, the base station side measures quality parameters indicating quality of a channel, but this embodiment has a feature that the quality parameters are measured on the terminal side. Hereinafter, this embodiment will be explained in detail.

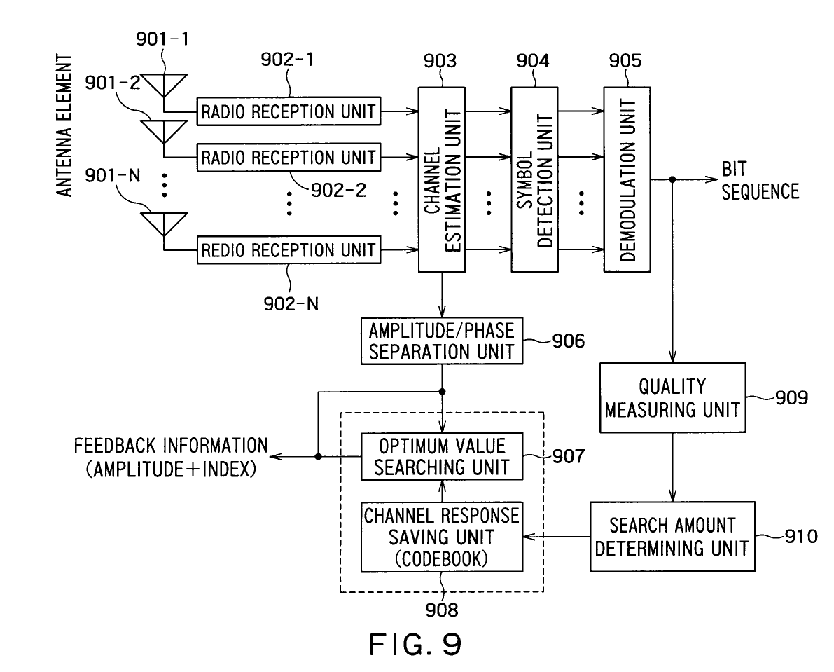

FIG. 9 schematically shows the configuration of a terminal in this embodiment. A radio signal received at antenna elements 901-1, 901-2, . . . 901-N is inputted to a channel estimation unit 903 through radio reception units 902-1, 902-2, . . . 902-N. Here, at a kth terminal, the signals received at the respective antenna elements 901-1, 901-2, . . . 901-N are expressed by above described Expression 1.

The channel estimation unit 903 calculates an estimated value Hₑₛₜ^{(k)} of a channel response matrix H^{(k)} from the received signal expressed by above described Expression 1. The number of columns of the channel response matrix Hₑₛₜ^{(k)} corresponds to the number of streams transmitted to the kth terminal.

A symbol detection unit 904 calculates an estimated value sₑₛₜ^{(k)} of a transmission signal s^{(k)} using the channel response matrix Hₑₛₜ^{(k)} estimated by the channel estimation unit 903. The calculated estimated value is converted to a bit sequence dₑₛₜ^{(k)} with Lₖ rows at a demodulation unit 905 that follows.

A quality measuring unit 909 measures parameters regarding quality of each stream at each terminal using the bit sequence (received signal) outputted from the demodulation unit 905. Examples of the “parameters regarding quality” include signal to noise ratio (SNR), CQI (Channel Quality Indicator), bit error rate (BER) and communication capacity. The measured parameters are inputted to a search amount determining unit 910.

The search amount determining unit 910 stores a table of correspondence between SNRs and parameters Pₗ^{(k)} regarding the amount of codebook search. Upon receiving an SNR value, the search amount determining unit 910 acquires the value of a parameter Pₗ^{(k)} regarding on the amount of codebook search based on this correspondence table as a natural number of B or less and reports the value to a channel response saving unit 908. The greater the SNR value, the smaller is the value set as the parameter regarding the amount of search. Even when BER and communication capacity are adopted as the parameters indicating quality as in the case of SNR, the table of correspondence between quality parameters and parameters regarding the amount of search is saved in the search amount determining unit 910. The search amount determining unit 910 corresponds to an example of an index of search number acquisition unit that acquires index of search number representing the number of candidates for a correlation calculation.

An amplitude/phase separation unit 906 separates the channel response matrix Hₑₛₜ^{(k)} estimated at the channel estimation unit 903 into an amplitude component αₗ^{(k)} and a phase component hₗ^{phase,(k)} as shown in above described Expression 2 for each column (each stream). The phase component hₗ^{phase,(k)} is outputted to an optimum value searching unit 907 to be subjected to matching with the codebook. The amplitude component is fed back to the base station together with the index obtained in the optimum value searching unit 907 as will be described later.

The channel response saving unit 908 stores a codebook made up of a set (h₁^{code}, . . . ,h₂_{^{code}}) of channel response values (here, phase components) as in the case of the first embodiment. Upon receiving the parameter Pₗ^{(k)} of amount of codebook search for each stream from the search amount determining unit 910, the channel response saving unit 908 selects a channel response value (here, phase component) to be subjected to matching with the output of the amplitude/phase separation unit 906 according to the parameter Pₗ^{(k)} of the amount of search from the codebook in the same way as FIG. 4 shown in the first embodiment and passes the selected channel response value (here, phase component) to the optimum value searching unit 907.

The optimum value searching unit 907 calculates (performs matching) a correlation between each column of the output (phase component hₗ^{phase,(k)}) of the amplitude/phase separation unit 906 and channel response value (here, phase component) in the codebook. The optimum value searching unit 907 selects a channel response value with the highest correlation value as the optimum channel response value (here, phase component) and outputs an index thereof.

Finally, the index of the codebook which is the output of the optimum value searching unit 907 and a positive real number αₗ^{(k)} corresponding to the amplitude of the channel response estimated value expressed by Expression 2 obtained by the amplitude/phase separation unit 906 are fed back to the base station as feedback information.

Next, the process of processing on the base station side will be explained.

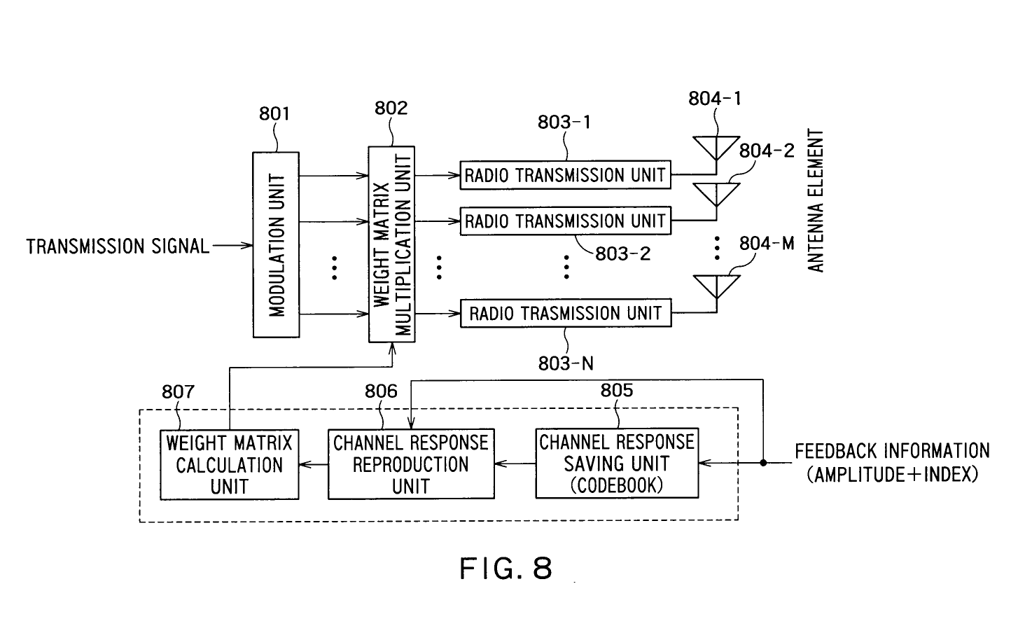

FIG. 8 schematically shows the configuration of the base station according to this embodiment. Feedback information (here, index and amplitude information αₗ^{(k)} (l=1, . . . ,Lₖ,k=1, . . . ,K) is fed back to the base station from the terminal. The index is inputted to a channel response saving unit 805 and the amplitude information αₗ^{(k)} (l=1, . . . Lₖ,k=1, . . . ,K) is inputted to a channel response reproduction unit 806.

The channel response saving unit 805 stores the same codebook (base station side codebook) as the channel response saving unit 908 in FIG. 9. The channel response saving unit 805 selects a channel response value (phase h_{l,selected}^{code(k)}) corresponding to the fed back index from the codebook and outputs the channel response value to the channel response reproduction unit 806.

The channel response reproduction unit 806 multiplies the amplitude αₗ^{(k)} of the channel response by the phase h_{l,selected}^{code(k)} of the channel response and reproduces the channel response value H_{select}^{(k)}=[h_{l,selected}^{code,(k)}, . . . ,h_{N}_{ₖ}_{,selected}^{code(k)}] (k=1, . . . ,K). This reproduced channel response value is inputted to a weight matrix calculation unit 807.

The weight matrix calculation unit 807 receives the H_{selected}^{(k)} with M rows and Nₖ columns corresponding in number to the terminals (K terminals) as input and calculates a transmission weight vector vₗ

$$( l = 1 , L , {\sum }_{k = 1}^{K} {L}_{k} )$$

assigned to each stream at each terminal. Various calculation methods can be considered and weights that suppress interference between terminals are required in a downlink MIMO-SDMA communication.

As shown above, a weight matrix for transmission beam forming by which each stream is multiplied is determined.

A modulation unit 801 modulates a transmission signal and generates a modulated signal. A weight matrix multiplication unit 802 multiplies the modulated signal by a weight matrix. That is, assuming the modulated signal is

$$s = {[ {s}_{1} , … , {s}_{{\sum }_{k = 1}^{K} {L}_{k}} ]}^{T} ,$$

the weight matrix multiplication unit 802 multiplies the modulated signal s by a weight matrix (output matrix of the weight matrix calculation unit 807)

$$V = [ {v}_{1} , … , {v}_{{\sum }_{k = 1}^{K} {L}_{k}} ] .$$

Each element of the multiplied signal (vector V·s) is emitted from the antenna elements 804-1, 804-2, . . . 804-M through the radio transmission units 803-1, 803-2, . . . 803-N.

The terminal receives the signal transmitted from the base station at antenna elements 901-1, 901-2, . . . 901-N and performs processing on the terminal side as described above hereinafter.

As described above, according to this embodiment, the terminal measures quality of the channel, determines the amount of codebook search according to the measured quality and performs matching with only the channel response value (here, phase component) corresponding to the determined amount of search and thereby drastically reduces the search load (amount of calculation) of the terminal compared to the conventional method carrying out a total codebook search. Therefore, the delay time and back off are reduced and the throughput of the entire system is improved.

### Fourth Embodiment

This embodiment has a feature that a quality parameter indicating quality of a channel is measured not by the base station but by the terminal side and a codebook is made up of transmission weight values. That is, this embodiment corresponds to a combination of the second and third embodiments. Hereinafter, this embodiment will be explained in detail.

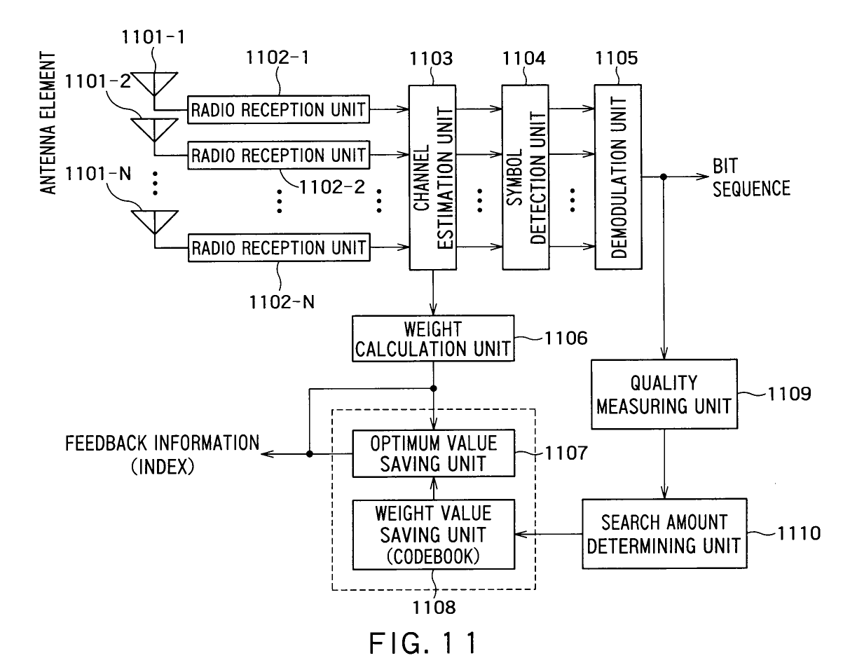

FIG. 11 schematically shows the configuration of a terminal according to a fourth embodiment. A radio signal received at antenna elements 1101-1, 1101-2, . . . 1101-N is inputted to a channel estimation unit 1103 through radio reception units 1102-1, 1102-2, . . . 1102-N. Here, at a kth terminal, a signal received at each antenna element 1101-1, 1101-2, . . . 1101-N is expressed by above described Expression 1.

The channel estimation unit 1103 calculates an estimated value Hₑₛₜ^{(k)} of a channel response matrix H^{(k)} from the received signal in above described Expression 1. The number of columns of the channel response matrix Hₑₛₜ^{(k)} corresponds to the number of streams transmitted to the kth terminal.

A symbol detection unit 1104 calculates an estimated value sₑₛₜ^{(k)} of a transmission signal s^{(k)} using the channel response matrix Hₑₛₜ^{(k)} estimated at the channel estimation unit 1103. The calculated estimated value is converted to a bit sequence dₑₛₜ^{(k)} with Lₖ rows at a demodulation unit 1105 that follows.

A quality measuring unit 1109 measures parameters regarding the quality of each stream at each terminal using the bit sequence (received signal) outputted from the demodulation unit 1105. Examples of the “parameters regarding the quality” include a signal to noise ratio (SNR), CQI (Channel Quality Indicator), bit error rate (BER) and communication capacity. The measured parameters are inputted to a search amount determining unit 1110 that follows.

The search amount determining unit 1110 stores a table of correspondence between SNRs and parameters Pₗ^{(k)} regarding the amount of codebook search. Upon receiving an SNR value as input, the search amount determining unit 1110 acquires the value of the parameter Pₗ^{(k)} regarding the amount of codebook search as a natural number of B or less based on this correspondence table and reports the value of the parameter to a weight saving unit 1108. When BER or communication capacity is adopted as a parameter indicating quality, a table of correspondence between quality parameters and parameters regarding the amount of search is saved in the search amount determining unit 1110 as in the case of SNR. The search amount determining unit 1110 corresponds, for example, to an example of the index of search number acquisition unit that acquires index of search number representing the number of candidates for a correlation calculation.

Furthermore, a weight calculation unit 1106 calculates a transmission weight matrix Vₑₛₜ^{(k)} from the channel response matrix Hₑₛₜ^{(k)} estimated at the channel estimation unit 1103 as expressed in the Expression 3.

The weight value saving unit 1108 stores a codebook made up of a set of weight values (v₁^{code}, . . . ,v₂_{^{B}}^{code}) as in the case of the second embodiment. Upon receiving the parameter Pₗ^{(k)} of amount of codebook search for each stream from the search amount determining unit 1110, the weight value saving unit 1108 selects a weight value with which matching with the output of the weight calculation unit 1106 is performed from the codebook as in the case of FIG. 7 shown in the second embodiment according to the parameter Pₗ^{(k)} of amount of search and passes the selected weight value to an optimum value searching unit 1107.

The optimum value searching unit 1107 calculates (performs matching) a correlation between each column of the weight value Vₑₛₜ^{(k)} calculated by the weight calculation unit 1106 and the weight value in the codebook. The optimum value searching unit 1107 selects one with the highest correlation value as the optimum weight value and outputs an index thereof.

Finally, the index of the codebook which is the output of the optimum value searching unit 1107 is fed back to the base station as feedback information.

Next, the process of processing on the base station side will be explained.

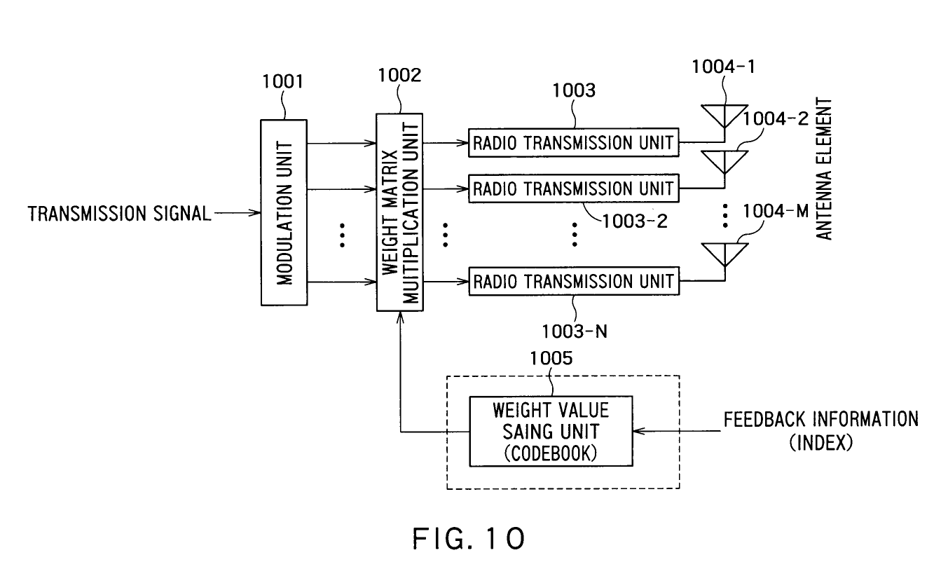

FIG. 10 schematically shows the configuration of the base station according to this embodiment. Feedback information (here, index of codebook) is returned from the terminal and the feedback information is inputted to a weight value saving unit 1005. The weight value saving unit 1005 stores the same codebook (base station side codebook) as that of the weight value saving unit 1108 in FIG. 11.

The weight value saving unit 1005 selects the weight value corresponding to the fed back index from the codebook. In this way, a weight matrix for transmission beam forming by which each stream is multiplied is obtained.

A modulation unit 1001 modulates a transmission signal and generates a modulated signal. A weight matrix multiplication unit 1002 multiplies the modulated signal by a weight matrix. That is, assuming that the modulated signal

$$is s = {[ {s}_{1} , … , {s}_{{\sum }_{k = 1}^{K} {L}_{k}} ]}^{T} ,$$

the weight matrix multiplication unit 1002 multiplies the modulated signal s by an output matrix

$$V = [ {v}_{1} , … , {v}_{{\sum }_{k = 1}^{K} {L}_{k}} ]$$

of the weight value saving unit 505. Each element of the multiplied signal (vector V·s) is emitted from antenna elements 1004-1, 1004-2, . . . 1004-M through radio transmission units 1003-1, 1003-2, . . . 1003-N.

The terminal receives a signal transmitted from the base station through the antenna elements 1101-1, 1101-2, . . . 1101-N and performs the processing on the terminal side as described above.

As shown above, according to this embodiment, the terminal measures quality of the channel, determines the amount of codebook search according to the measured quality and performs matching with only the weight value of the determined amount of search, and can thereby drastically reduce the search load (amount of calculation) of the terminal compared with the conventional method whereby the entire codebook is searched. Therefore, the delay time and back off are reduced and the throughput of the entire system is improved.

### Fifth Embodiment

This embodiment has a feature that an index of the number of bits according to the amount of search is fed back to the base station. Other aspects are the same as those in the first embodiment. Hereinafter, this embodiment will be explained in detail.

The basic configurations of the base station and terminal according to this embodiment are similar to those in FIG. 2 and FIG. 3. That is, the base station in FIG. 2 transmits a parameter Pₗ^{(k)} regarding the amount of search determined by the search amount determining unit 209 to the terminal together with a data signal and the terminal side in FIG. 3 selects 2^{P}^{ₗ}^{^{(k)}} candidate values from among 2^{B} channel response values (here, phase components) as shown in FIG. 4 and performs matching with only the selected candidate value.

Here, the first embodiment fixes the number of bits of an index of the codebook used for feedback as B bits. That is, the first embodiment assigns serial numbers including (2^{B}−2^{P}^{ₗ}^{^{(k)}}) channel response values (here, phase components) not used for a search and performs feedback.

In contrast, when an optimum channel response value (here, phase component) is searched through matching with 2^{P}^{ₗ}^{^{(k)}} candidate values, this embodiment assigns an index of Pₗ^{(k)} bits that can identify only actually searched 2^{P}^{ₗ}^{^{(k)}} channel response values and feeds back this index. That is, this embodiment assigns an index of Pₗ^{(k)} bits to each of 2^{P}^{ₗ}^{^{(k)}} candidate values to be searched and feeds back indexes of the selected candidate values (feeds back 2 bits in the case of a 2-bits search or 3 bits in the case of a 3-bit search).

When this is explained from a different standpoint, first to nth candidate groups (or first to nth group) are associated beforehand with first to nth amounts of search (first to nth numbers of candidates). An index of P bits is then assigned to each candidate value for each candidate group. That is, each candidate group is provided with a specific index system. These pieces of information are shared with the base station beforehand. The terminal then specifies a candidate group associated with the amount of search reported from the base station from the first to nth candidate groups, selects a candidate value with the highest correlation through matching with the specified candidate group. The index of the selected candidate value is determined according to which of the first to nth candidate groups. The terminal then feeds back the index to the base station.

Using such a feedback method can reduce the feedback information from B bits to Pₗ^{(k)} bits. As in the case of the first embodiment, matching is performed at intervals of 2^{B-P}^{ₗ}^{^{(k)}}−1 candidates from hₗ_{₀}^{code} (l₀<2^{B-P}^{ₗ}^{^{(k)}}). However, the value of l₀ needs to be shared between the base station and the terminal beforehand.

Since the amount of search and the above described value of lo are known to the base station, it is possible to detect a channel response value (here, phase component) without an error from the codebook based on the index fed back from the terminal. That is, the channel response value (here, phase component) can be uniquely specified from the codebook based on the number of bits of the index fed back from the terminal and the value.

It is apparent that the above described idea of reducing the amount of feedback according to this embodiment is also applicable to a case where the codebook is made up of weight values as in the case of the second embodiment.

As described above, this embodiment can reduce the amount of feedback from B bits to P bits by reducing the amount of codebook search from 2^{B} to 2^{P}. This can reduce the feedback load and realize improvement of the throughput of the entire system. Alternatively, the reduced amount may be used to transmit other information and can thereby increase the amount of information within a limited band.

### Sixth Embodiment

This embodiment feeds back an index with a number of bits corresponding to the amount of search to the base station as in the case of the fifth embodiment, but this embodiment differs from the fifth embodiment in that the amount of search is determined on the terminal side. The basic configurations of the base station and terminal of this embodiment are similar to those in FIG. 8 and FIG. 9.

According to this embodiment, since the base station side does not know the amount of search, the terminal feeds back a parameter regarding the amount of search Pₗ^{(k)} in addition to the amplitude information and index to the base station. As explained in the fifth embodiment, this allows the base station to select a channel response value (here, phase component) from the codebook without any errors.

It is apparent that the idea of reducing the amount of feedback of this embodiment is also applicable as is to a case where the codebook is made up of weight values as in the case of the fourth embodiment.

### Seventh Embodiment

This embodiment has a feature that a tree structure is used to detect an optimum channel response value (here, phase component) form a codebook. Other aspects are the same as those in the first embodiment. Hereinafter, this embodiment will be explained in detail.

In the first embodiment, as shown in FIG. 3, the channel response saving unit 308 selects candidate values corresponding in number to 2^{P}^{ₗ}^{^{(k)}} values to be searched at equal intervals from the entire codebook and the optimum value searching unit 307 performs matching.

In contrast, this embodiment starts matching with 2^{P}^{₀} candidate values using a relatively small value P₀ as the initial value, repeats the search only around a selected index and thereby carries out a search hierarchically up to a searching density corresponding to matching of 2^{P}^{ₗ}^{^{(k)}} candidate values. The parameter Pₗ^{(k)} regarding the amount of search corresponds, for example, to a repetition parameter R. The optimum value searching unit 307 includes a control unit that controls the channel response saving unit 308 (candidate selecting unit).

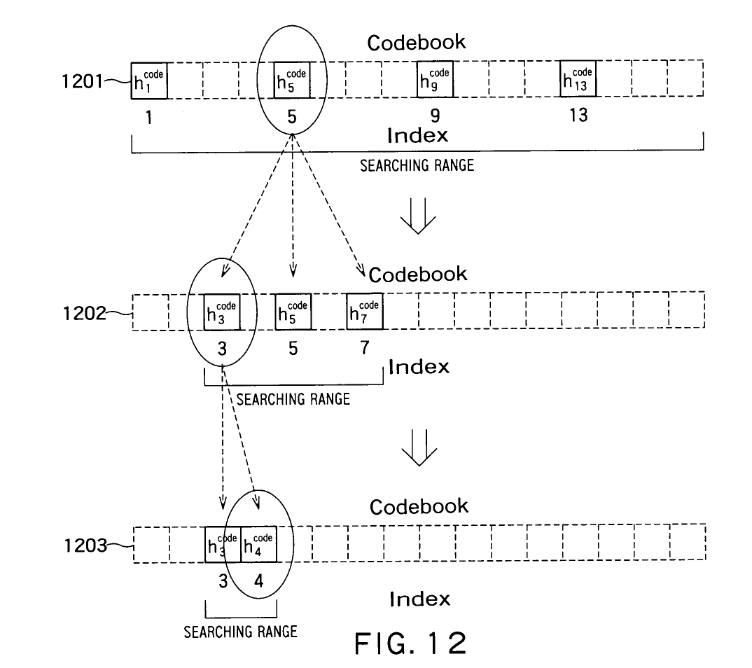

FIG. 12 illustrates a search method according to this embodiment. Here, a search example where an initial value P₀=2 and amount of search Pₗ^{(k)}=4 will be shown. Furthermore, the number of channel response values (here, phase components) in a codebook is assumed to be 2⁴=16. (Step 1) Since P₀=2, matchings with 2²=4 candidate values [h₁^{code},h₅^{code},h₉^{code},h₁₃^{code}] as shown by reference numeral 1201 in FIG. 12 are performed first. That is, an initial value 2 (=P₀) is substituted into a variable x and matchings are performed with candidate values placed at intervals of 2^{B-x}−1 values. Here, suppose h₅^{code} is selected as an optimum value. (Step 2) Next, as shown by reference numeral 1202, a search is performed assuming P=3 and the search is performed only around [h₃^{code},h₅^{code},h₇^{code}] of h₅^{code} this time. In this case, since a correlation value with h₅^{code} has already been obtained in the immediately preceding step, only a correlation value with [h₃^{code},h₇^{code}] needs to be obtained. As a result, suppose h₃^{code} has been selected as an optimum value (first optimum value).

In this way, 1 is added to the variable x to obtain 3 in this step, and between the first optimum value selected in step 1 and adjacent candidate values adjacent to the first optimum value out of candidate values subjected to the correlation calculation in step 1, correlation values with candidate values placed at intervals of 2^{B-x}−1 values from the first optimum value are calculated. One with a maximum value out of the calculated correlation value and the first optimum value is selected as the optimum value (second optimum value) in this step.

(Step 3) Next, a search is performed assuming P=4 as shown by reference numeral 1203, and a search is performed only around [h₃^{code}, h₄^{code}] of h₃^{code} this time. That is, if h₂^{code} is assumed to be a candidate, h₁^{code} must have been selected as a more approximate value in the first step, and therefore h₂^{code} need not be searched. Furthermore, a correlation value with h₃^{code} has already been obtained. Therefore, only a correlation value with h₄^{code} needs to be calculated.

In this way, in this step, 1 is added to the variable x to obtain 4 and between the second optimum value selected in step 2 and adjacent candidate values adjacent to this second optimum value out of the candidate values subjected to the correlation calculation in step 2, correlation values with candidate values placed at intervals of 2^{B-x}−1 values from the second optimum value are calculated. One with a maximum value out of the calculated correlation value and the second optimum value is selected as the optimum value (third optimum value) in this step.

Since P reaches an amount of search (Pₗ^{(k)}=4) (variable x reaches 4), the search is finished, and as a result, h₄^{code} (third optimum value) becomes a channel response value (here, phase component) to be eventually selected.

As opposed to the first embodiment in which 16 searches with Pₗ^{(k)}=4 are necessary, this embodiment only requires a total of seven searches; four searches in step 1 shown by reference numeral 1201 in FIG. 12, two searches in step 2 shown by 1202 and one search in step 3 shown by 1203. The resolution of the channel response values (here, phase components) obtained is the same as that of the first embodiment. That is, the parameter Pₗ^{(k)} regarding the amount of search represents final resolution of search and adopting the improvement in this embodiment can reduce the amount of calculation required for a search.

Here, this embodiment has been presented in a comparison with the first embodiment, but a technique similar to this embodiment is also applicable as is to a case where a codebook is made up of weight values as in the second embodiment and a case where the terminal side determines the amount of codebook search as in the third and fourth embodiments.

The base station and the terminal apparatus of each embodiment may also be realized using a general-purpose computer device as basic hardware. That is, the modulation unit, weight matrix multiplication unit, radio transmission unit, weight matrix calculation unit, channel response reproduction unit, quality measuring unit and search amount determining unit in the base station, and the radio reception unit, channel estimation unit, symbol detection unit, demodulation unit, amplitude/phase separation unit, optimum value searching unit, search amount detection unit, quality measuring unit and weight calculation unit in the terminal apparatus can be realized by causing a processor mounted in the above described computer device to execute a program. In this case, the base station and the terminal apparatus may be realized by installing the above described program in the computer device beforehand or may be realized by storing the program in a storage medium such as a CD-ROM or distributing the above described program over a network and installing this program in the computer device as appropriate. Furthermore, the channel response saving unit and the weight value saving unit may also be realized using a memory device or hard disk incorporated in or externally added to the above described computer device or a storage medium such as CD-R, CD-RW, DVD-RAM, DVD-R as appropriate.

The present invention is not limited to the exact embodiments described above and can be embodied with its components modified in an implementation phase without departing from the scope of the invention. Also, arbitrary combinations of the components disclosed in the above-described embodiments can form various inventions. For example, some of the all components shown in the embodiments may be omitted. Furthermore, components from different embodiments may be combined as appropriate.

What is claimed is:

1. A terminal apparatus comprising:
a reception unit configured to receive a signal from a base station;
a channel estimation unit configured to estimate a state of a channel based on a received signal to obtain an estimated state value of the channel;
a storage configured to store a codebook including a plurality of channel state values;
an index of search number acquisition unit configured to acquire index of search number representing a number of candidates to be selected from among the channel state values in the codebook for a correlation calculation with the estimated state value;
a candidate selecting unit configured to select candidates for which the correlation calculation with the estimated state value should be performed from among the channel state values according to the index of search number;
a correlation calculation unit configured to calculate a correlation between the estimated state value and each of selected candidates;
a selection unit configured to select a candidate having a highest correlation value from among the selected candidates; and
a reporting unit configured to report a selected candidate to the base station.

2. The apparatus according to claim 1, wherein the channel state values in the codebook are arranged in descending order of correlations with respect to a reference channel state value which is one of the channel state values.

3. The apparatus according to claim 1, wherein the codebook includes 2^{B} channel state values,
the number of candidates is expressed by 2^{P} (P<B),
the candidate selecting unit selects channel state values placed at intervals of 2^{B-P}−1 in the codebook as the candidates.

4. The apparatus according to claim 1, wherein the index of search number acquisition unit acquires the index of search number via a report from the base station.

5. The apparatus according to claim 4, wherein the codebook includes 2^{B} channel state values,
the index of search number acquisition unit acquires any one of first to nth index of search number,
the first to nth index of search number are expressed by 2^{P} (P<B) using different Ps, respectively
first to nth group each including plural candidates according to the first to nth number are provided beforehand;
an index of P bits is assigned to each of the candidates for each of the first to nth group,
the candidate selecting unit specifies a group associated with the acquired index of search number from among the first to nth group, and
the reporting unit reports an P bits index determined according to a specified group among the first to nth group, for the selected candidate.

6. The apparatus according to claim 1, further comprising a quality measuring unit configured to measure quality of the channel based on the received signal,
the index of search number acquisition unit calculates the index of search number according to measured quality of the channel.

7. The apparatus according to claim 6, further comprising a table configured to associate quality of the channel with index of search number,
wherein the index of search number acquisition unit acquires index of search number corresponding to measured quality of the channel from the table.

8. The apparatus according to claim 1, further comprising a quality information acquisition unit configured to acquire quality information indicating quality of the channel from the base station,
wherein the index of search number acquisition unit calculates the index of search number according to acquired quality of the channel.

9. The apparatus according to claim 8, further comprising a table configured to associate quality of the channel with index of search number,
wherein the index of search number acquisition unit acquires the number of candidates with reference to the table based on the acquired quality of the channel.

10. The apparatus according to claim 4, wherein the codebook includes 2^{B} channel state values,
the index of search number acquisition unit acquires any one of first to nth index of search number,
the first to nth index of search number are expressed by 2^{P} (P<B) using different Ps, respectively
first to nth group each including plural candidates are associated beforehand with the first to nth index of search number;
an index of P bits is assigned to each of the candidates for each of the first to nth group,
the candidate selecting unit specifies a group associated with the acquired index of search number from among the first to nth group, and
the reporting unit reports an P bits index determined according to a specified group among the first to nth group, for the selected candidate and reports the acquired index of search number.

11. The apparatus according to claim 1, further comprising a control unit configured to control the candidate selecting unit,
the channel state values in the codebook are arranged in descending order of correlations with respect to a reference channel state value which is one of the channel state values,
the codebook includes 2^{B} channel state values,
the index of search number acquisition unit acquires a repetition parameter R (R<B) representing the number of candidates, as the index of search number
(1) the candidate selecting unit substitutes an initial value p0 of less than R into a variable x, determines channel state values placed at intervals of 2^{B-x}−1 in the codebook as candidates and the selection unit selects one candidate from selected candidates,
(2) the control unit adds 1 to x,
(3) the candidate selecting unit further selects channel state values arranged at intervals of 2^{B-x}−1 with respect to the one candidate between the one candidate and adjacent candidates to the one candidate in the selected candidates and the selection unit further selects one candidate from among the one candidate and further selected candidates,
(4) the control unit repeats (2) and (3) until the value of x reaches R, and
the reporting unit reports an index of a candidate finally selected by the selection unit to the base station.

12. A communication method comprising:
receiving a signal from a base station;
estimating a state of a channel based on a received signal to obtain an estimated state value of the channel;
providing a codebook including a plurality of channel state values;
acquiring index of search number representing a number of candidates to be selected from among the channel state values in the codebook for a correlation calculation with the estimated state value;
selecting candidates for which the correlation calculation with the estimated state value should be performed from among the channel state values in the codebook according to the index of search number;
calculating a correlation between the estimated state value and each of selected candidates;
selecting a candidate having a highest correlation value from among the selected candidates; and
reporting a selected candidate to the base station.

13. A program storage medium storing a computer program for causing a computer to execute instructions to perform the steps of:
receiving a signal from a base station;
estimating a state of a channel based on a received signal to obtain an estimated state value of the channel;
reading out a codebook including a plurality of channel state values from a codebook storage;
acquiring index of search number representing a number of candidates to be selected from among the channel state values in the codebook for a correlation calculation with the estimated state value;
selecting candidates for which the correlation calculation with the estimated state value should be performed from among the channel state values in the codebook according to the index of search number;
calculating a correlation between the estimated state value and each of selected candidates;
selecting a candidate having a highest correlation value from among the selected candidates; and
reporting a selected candidate to the base station.

14. A base station for communicating with a terminal apparatus, the terminal apparatus estimating a state of a channel to obtain an estimated state value of the channel and calculating a correlation between the estimated state value and each of candidates selected from a codebook which includes channel state values to detect a candidate having a high correlation with the estimated state value, comprising:
a quality measuring unit configured to measure quality of a channel between the base station and the terminal apparatus;
a storage configured to store a base station side codebook having same contents as the codebook of the terminal apparatus;
an index acquisition unit configured to acquire an index of the candidate detected by the terminal apparatus from the terminal apparatus;
a selecting unit configured to select a channel state value having an acquired index from the base station side codebook;
a weighted signal generation unit configured to multiply a transmission signal to the terminal apparatus by a weight depending on a selected channel state value to generate a weighted signal;
a transmission unit configured to transmit the weighted signal to the terminal apparatus;
an index of search number determining unit configured to determine index of search number representing a number of the candidates to be selected from the codebook in the terminal apparatus, based on measured quality of the channel; and
a reporting unit configured to report the index of search number to the terminal apparatus.

15. A communication method performed by a base station which communicates with a terminal apparatus, the terminal apparatus estimating a state of a channel to obtain an estimated state value of the channel and calculating a correlation between the estimated state value and each of candidates selected from a codebook which includes channel state values to detect a candidate having a high correlation with the estimated state value, comprising:
measuring quality of a channel between the base station and the terminal apparatus;
providing a storage configured to store a base station side codebook having same contents as the codebook of the terminal apparatus;
acquiring an index of the candidate detected by the terminal apparatus from the terminal apparatus;
selecting a channel state value having an acquired index from the base station side codebook;
multiplying a transmission signal to the terminal apparatus by a weight depending on a selected channel state value to generate a weighted signal;
transmitting the weighted signal to the terminal apparatus;
determining index of search number representing a number of the candidates to be selected from the codebook in the terminal apparatus, based on measured quality of the channel; and
reporting the index of search number to the terminal apparatus.

16. A program storage medium storing a computer program for causing a base station which communicates with a terminal apparatus, the terminal apparatus estimating a state of a channel to obtain an estimated state value of the channel and calculating a correlation between the estimated state value and each of candidates selected from a codebook which includes channel state values to detect a candidate having a high correlation with the estimated state value, to execute instructions the steps of:
measuring quality of a channel between the base station and the terminal apparatus;
reading out a base station side codebook identical to the codebook of the terminal apparatus, from a codebook storage;
acquiring an index of the candidate detected by the terminal apparatus from the terminal apparatus;
selecting a channel state value having an acquired index from the base station side codebook;
multiplying a transmission signal to the terminal apparatus by a weight depending on a selected channel state value to generate a weighted signal;
transmitting the weighted signal to the terminal apparatus;
determining index of search number representing a number of the candidates to be selected from the codebook in the terminal apparatus, based on measured quality of the channel; and
reporting the index of search number to the terminal apparatus.
